(19) United States
(12) Patent Application Publication
(10) Pub. No.: US 2005/0267835 A1
(43) Pub. Date: Dec. 1, 2005

(54) System and method for evaluating exposure across a group of investment portfolios by category

(76) Inventors: Scott Condron, Armonk, NY (US); Roland Villacorta, New York, NY (US); Cheewee Chew, Princeton, NJ (US)

Correspondence Address: EDWARDS & ANGELL, LLP, P.O. BOX 55874, BOSTON, MA, 02205, US

(21) Appl. No.: 11/026,804

(22) Filed: Dec. 30, 2004

Related U.S. Application Data
(60) Provisional application No. 60/533,616, filed on Dec. 31, 2003.

(51) Int. Cl. G06F 17/60; G06F 17/00

(52) U.S. Cl. 705/37; 707/100

(57) ABSTRACT

A system and method are disclosed for evaluating risk exposure across portfolios of investments. The system and method involves storing portfolio data and investment data in a portfolio database, selecting portfolios of interest from the portfolio database, selecting a rule for categorizing the investments in the selected portfolios of interest, selecting a comparative parameter, categorizing the investments contained in the selected portfolios according to the selected rule and quantifying the exposure of the selected portfolios for each category of investments in terms of the selected comparative parameter.

### CROSS-REFERENCE TO RELATED APPLICATIONS

This application claims priority to U.S. Provisional Patent Application No. 60/533,616, filed Dec. 31, 2003, which is herein incorporated by reference in its entirety to the extent it is not inconsistent with this disclosure

### COPYRIGHT NOTICE

A portion of the disclosure of this patent document contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND OF THE INVENTION

1. Field of the Invention

The subject invention relates to financial portfolio management, and more particularly, to a system and method for categorizing the financial instruments and quantifying the exposure due to across a selected group of investment portfolios by each category.

2. Background of the Related Art

The primary objectives of a portfolio manager are to maximize the total return on investments and generate a high level of current income for the investor. In pursuit of these objectives, portfolio managers focus their attention on the inherent risk associated with the investments in the portfolio, that is, the quantifiable likelihood of loss or less-than-expected returns that may occur due to market volatility or unforeseen events, such as geopolitical or economic disturbances. More importantly, portfolio managers must be mindful of the exposure of portfolios under their care.

As a strategy to reduce exposure to risk, portfolio managers develop portfolios of diversified investments, such as stocks, bonds, real estate, etc. This strategy relies on the limits of market volatility, one of which is that not all asset classes or industries or individual companies, etc., will fluctuate up or down in value at the same time or at the same rate. The optimal result is that both the upside and downside potential are reduced to generate consistent performance under a wide range of economic conditions, yielding a minimal net risk and a close to certain expected return.

Thus, the optimization of a portfolio requires that the risk associated with the investments within the portfolios be characterized to determine the potential exposure to any specific risk before the optimal amounts or weights of securities in a portfolio are decided. This task is difficult since risk is typically dependent on a variety of factors, some of which may be seemingly unrelated. For example, a company's stock may rise or fall based on the financial success of the company, but other factor, such as the general health of businesses in the same industry sector, the company's suppliers, world events, the economic state of the country in general, etc., may contribute significantly to the extent of the fluctuations. Thus, portfolio managers often determine exposure values relative to specific investments to minimize the exposure to any specific risk factor, as well as groups of investments having common attributes, to minimize any indirect risk. Since portfolio managers typically care for groups of numerous diversified portfolios, each containing hundreds of different investments, the exposure analyses become overly burdensome and complex.

In addition, portfolio managers often use portfolios that have proven successful at generating consistent performance as a model or benchmark to optimize portfolio diversification by determining and comparing the exposure values of both. Using the benchmark as a guide, the portfolio manager can determine whether the portfolio is underweighted (i.e., containing too little exposure to a given company, sector, market, etc.), or conversely, overweighted (i.e., containing too much exposure). By determining the exposure relative to the benchmark, the portfolio manager can decide whether further diversification is necessary and trade investments accordingly.

For example, a portfolio manager for a high yield bond fund may seek to outperform the Lehman Brothers High Yield Bond Index or use a similar index as a benchmark, while investing primarily in high quality market sectors (e.g., BB or above) and selectively in low quality issuers (e.g., CCC or below). To such an end, the manager may seek, for example, to limit individual low quality issuer exposure to 5% and no more than 1% of the total index weight. Thus, for one, the portfolio manager would analyze the fund to determine whether investments were high quality market sectors and the relative weight of such investments as compared to the benchmark. The portfolio manager would run a similar analysis to determine the relative weighting of individual low quality issuers.

There are numerous other reasons why a portfolio manager might decide to adjust investments in a portfolio. The intensity of the analyses increase depending on whether the basis for comparison is weighting, total market value, net asset value, or various combinations of parameters. Up to now, portfolio managers in charge of managing groups of portfolios containing hundreds of investments were confronted with an extremely time-consuming and cumbersome job if they wanted to determine absolute or relative exposure values due to a particular attribute or category of investment across their portfolios, using just one comparative parameter. Clearly, there is a need in the art for a method and system that enables portfolio managers to effectively and efficiently determine and evaluate the absolute and relative exposure for groups of investments and multiple portfolios.

### SUMMARY OF THE INVENTION

The subject invention solves the aforementioned problems by providing the portfolio manager with a new and useful computer-based system and method for conducting multiple exposure analyses simultaneously across portfolios in a portfolio group.

In particular, the present invention is directed to a system for evaluating risk exposure across portfolios of investments. This system includes a database for storing portfolio data and investment data. The portfolio data relates to groupings of investments and the investment data includes information relating to attributes associated with the investment. The aforementioned system is also equipped or includes devices that allow it to select a portfolio of interest from the database; select a rule for categorizing the investments in the selected portfolio of interest by associated attributes included in the investment data; select a comparative parameter; categorize the investments contained in the selected portfolio of interest according to the selected rule; and quantify the exposure of the selected portfolio of interest for each category of investments in terms of the selected comparative parameter. The comparative parameter may be a variable such as the market value, net asset value, duration dollar, etc.

Preferably, the aforementioned system is capable of quantifying the exposure as a whole and by each category and/or subcategory, and is also able to determine the absolute and relative exposures of the selected portfolios to the investments by category and subcategory in terms of the selected comparative parameter.

The aforementioned system can also be capable of illustrating the results of the exposure analysis, that is, the quantification of the exposure for the selected portfolios in terms of the selected comparative parameter, in a graphical and/or spreadsheet format. Preferably, the graphs and/or spreadsheets are interactive, in that the graph and spreadsheet are responsive to computer-based stimuli to provide alternate views, data or illustrations relating to exposure in the portfolio. The aforementioned system is also preferably configured for delivering the quantified exposure in an electronic mail.

The present invention is also directed to a method for evaluating risk exposure across portfolios of investments. This method can include the steps of storing portfolio data and investment data, wherein the portfolio data relates to groupings of investments and the investment data includes information relating to attributes associated with the investments; selecting a portfolio of interest from the database; selecting a rule for categorizing the investments in the selected portfolio of interest by associated attributes included in the investment data; selecting a comparative parameter; categorizing the investments contained in the selected portfolio of interest according to the selected rule; and quantifying the exposure of the selected portfolio of interest for each category of investments in terms of the selected comparative parameter.

The step involving quantifying the exposure of the selected portfolio of interest for each category of investments in terms of the selected comparative parameter in the aforementioned method can also include quantifying total, absolute and relative exposure values in terms of the selected comparative parameter for the portfolio as a whole, and each category and subcategory.

Preferably, the aforementioned method includes the step of illustrating the exposure in terms of the selected comparative parameter of the selected portfolio to the investments by category in a graphical or spreadsheet format. Preferably, the spreadsheets and/or graphs are interactive. The method of the present invention can also include the step of illustrating the exposure in an electronic mail.

The present invention is further directed to an executable program for implementing a system or method for evaluating risk exposure across portfolios of investments on a computer, such as the aforementioned systems and methods. This executable program can be stored on a computer or machine readable media, provided by a connection to a data transfer device, or accessible through a website on the World Wide Web.

The present invention is also directed to a machine readable media for facilitating evaluation of risk exposure across portfolios of investments on a computer. The media can include a data segment for storing portfolio data and investment data, wherein the portfolio data relates to the groupings of investments and the investment data includes information relating to a plurality of attributes associated with investments; and code segments for, among other things, selecting a portfolio of interest from the database, selecting a rule for categorizing investments in the selected portfolio of interest by associated attributes included in the investment data, selecting a comparative parameter, categorizing the investments contained in the selected portfolio of interest according to the selected rule, and quantifying the exposure of the selected portfolio of interest for each category of investments in terms of the selected comparative parameter.

These and other aspects of the system and method of the subject invention will become more readily apparent to those having ordinary skill in the art from the following detailed description of the invention taken in conjunction with the drawings.

### BRIEF DESCRIPTION OF THE DRAWINGS

So that those having ordinary skill in the art to which the present invention pertains will more readily understand how to make and use the method and system of the present invention, embodiments thereof will be described in detail hereinbelow with reference to the drawings, wherein:

FIG. 1 is a schematic diagram depicting the core functional components of a computer-based system for evaluating issuer exposure across a group of investment portfolios, which is configured in accordance with a preferred embodiment of the subject invention;

FIG. 2 is a depiction of a graphical user interface configured in accordance with a preferred embodiment of the subject invention, which enables a portfolio manager to configure an exposure analysis including selecting portfolios for evaluation, designating the comparative parameter and setting the rule by which the investments in the portfolios will be categorized;

FIG. 3 depicts another graphical user interface which enables a portfolio manager to further configure an exposure analysis, including setting the portfolio group, view options and security type coverage for an exposure evaluation to be conducted by a system in accordance with the present invention;

FIGS. 4-6 depict graphical user interfaces for presenting various views of data resulting from an exemplary analysis entitled “Displaying % NAV for LEH Sector & Issuer by Portgroup Tree (Issuers Only),” which was configured and processed in accordance with the system and method of the present invention;

FIGS. 7-10 depict graphical user interfaces for presenting various views of data resulting from an exemplary analysis entitled “Displaying % NAV for Currency & Sec. Type & LEH Sector & Issuer by Portgroup Tree (Issuers Only),” which was configured and processed in accordance with the system and method of the present invention;

FIGS. 11-12 depict graphical user interfaces for presenting two views of data resulting from an exemplary analysis entitled “Displaying Market Value for Issuer by Portgroup Tree (Issuers Only) (in USD),” which was configured and processed in accordance with the system and method of the present invention;

FIG. 13 depicts a graphical user interface for presenting data resulting from an exemplary analysis entitled “Displaying % NAV for Portgroup Tree by Credit Type & Issuer (All Credits),” which was configured and processed in accordance with the system and method of the present invention;

FIGS. 14-15 depict graphical user interfaces for presenting data resulting from an exemplary analysis entitled “Displaying Exposure for Portgroup by Ult. Issuer & Credit Type & Issuer,” which was configured and processed in accordance with the system and method of the present invention;

FIG. 16 depicts a graphical user interface for presenting data resulting from an exemplary analysis entitled “Displaying positions for ALL_FUNDS on Dec. 7, 2004 with DD exposure (All credits) in USD. NAV as of Dec. 7, 2004. Only Exposed Portfolios,” which was configured and processed in accordance with the system and method of the present invention; and

FIG. 17 depicts a graphical user interface for forwarding a direct access link to an exposure analysis configured and processed in accordance with the system and method of the present invention to a recipient via e-mail.

### DETAILED DESCRIPTION OF PREFERRED EMBODIMENTS

The subject invention is directed to a new and useful system and method for, among other things, enabling a portfolio manager, trader, investor, or custodian of a group of investments to effectively and efficiently determine and evaluate exposure for the investments contained in selected investment portfolios, and determine and evaluate exposure for groups of investments across groups of portfolios based on attributes associated with the investments.

The investment portfolios selected for evaluation may be related to one another in a particular manner or they may be wholly unrelated. Similarly, the investments selected for evaluation across the portfolios may be related in a particular manner and have common attributes, such as, industry sector or issuer, or they too may be wholly unrelated to one another.

It should be understood that a system and method according to the present invention can be incorporated in or integrated with a computerized system having analytical programs and an analytical processor configured to provide intra-day and inter-day real-time analyses. The system and method of the subject invention can be used in conjunction with a trading system configured to execute trades to adjust reduce or increase exposure for, among other things, multiple investment portfolios. Those skilled in the art will readily appreciate that a system and method configured in accordance with the present disclosure may be used as a standalone system, or in conjunction with systems other than the system described herein.

Those skilled in the art will also readily appreciate that a system configured in accordance with the subject invention includes various computer and network related software and hardware as is commonly used in a distributed computing network. This includes programs, operating systems, memory storage devices, input/output devices, data processors, servers with links to data communication systems, wireless or otherwise, such as those which take the form of a local or wide area network, and a plurality of data terminals within the network, such as personal computers. Those skilled in the art will further appreciate that, as long as users are provided with access to a system and method constructed in accordance with the present disclosure, the type of network, software or hardware that is employed is not vital to the full implementation of the invention.

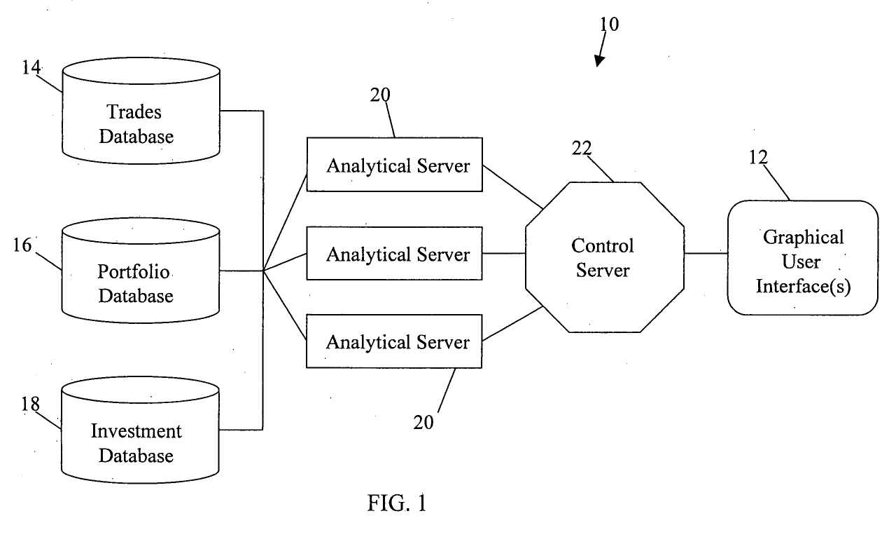

Referring now to the drawings wherein like reference numerals generally identify similar aspects, components or features of the subject invention, there is illustrated in FIG. 1 a schematic representation of the core functional components of the computerized issuer exposure evaluation system of the subject invention, which is designated generally by reference numeral 10. It should be understood that exposure evaluation system 10 is adapted and configured to function independently, while also interacting with other web-based systems such as, for example, an enterprise investment management system that features trade entry, trade settlement, cash management and payment processing tools, as well as an integrated compliance module which monitors investment decisions to ensure that the investment and portfolio composition as a whole remain in compliance with the investment objectives of a particular investor.

Referring to FIG. 1, system 10 provides, preferably through one or more graphical user interfaces (GUI) 12, a system for evaluating issuer exposure across a group of investment portfolios. Preferably, the graphical user interface (also referred to herein as “screens”) used by system 10 incorporates user-friendly features and fits seamlessly with other operating system interfaces, that is, in a framed form having borders, toolbars, pull-down menus, embedded links to other screens and various other selectable features associated with animated graphical representations of depressible buttons. Such features can be selected with an associated mouse, keyboard or any tool for indicating a preference in a graphical environment.

With continuing reference to FIG. 1, graphical user interfaces 12 defines collectively the input and output devices for system 10, which enables portfolio managers, traders and the like to receive, access, analyze, review and/or report data in accordance with the present invention. These devices are operatively associated with a data storage source that preferably contains, among other things, a trades database 14, a portfolio database 16 and an investment database 18. Databases 14, 16, and 18 collectively store a plurality of investment portfolios each containing investments, such as fixed income securities, trade and investment data, including associated attributes such as issuer and sector types or classifications, among other things, and are updated on a regular basis, typically each day. In this embodiment, a plurality of analytical servers 20 and a control and cache server 22 provide expandable, load balancing operative support for system 10. Analytical servers 20 and control server 22 can include one or more processors and control programs containing instruction sets written in a conventional computing language such as HTML, C++ or Java, for coordinating the interactive relationship between graphical user interfaces 12 and databases 14, 16 and 18, respectively.

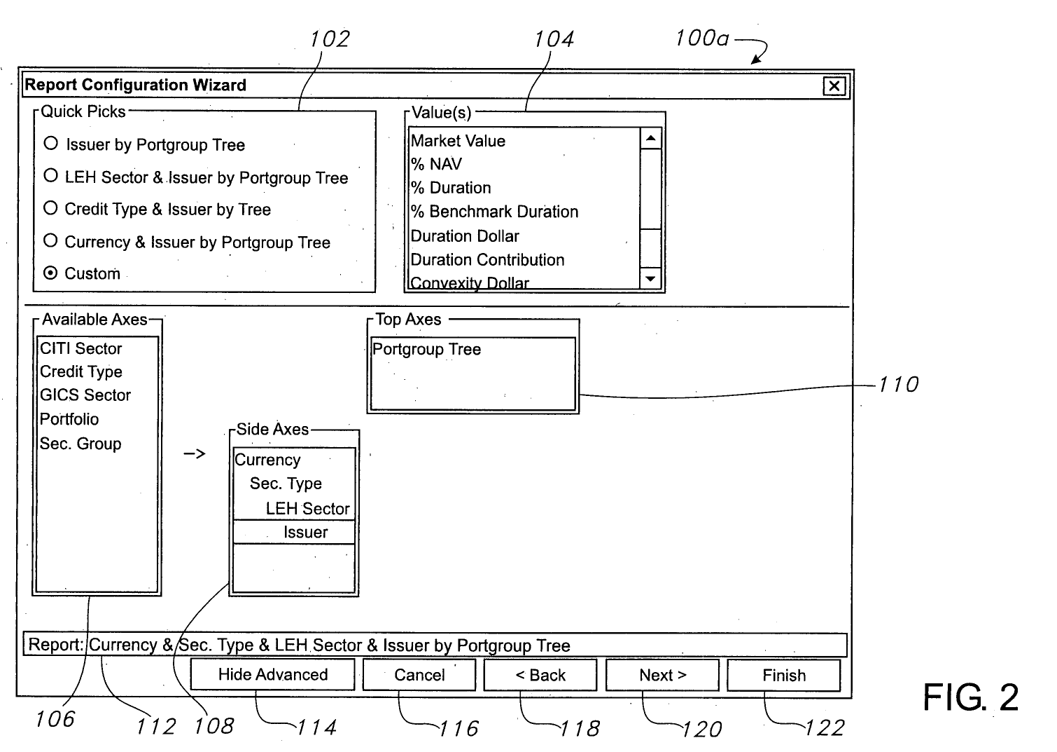

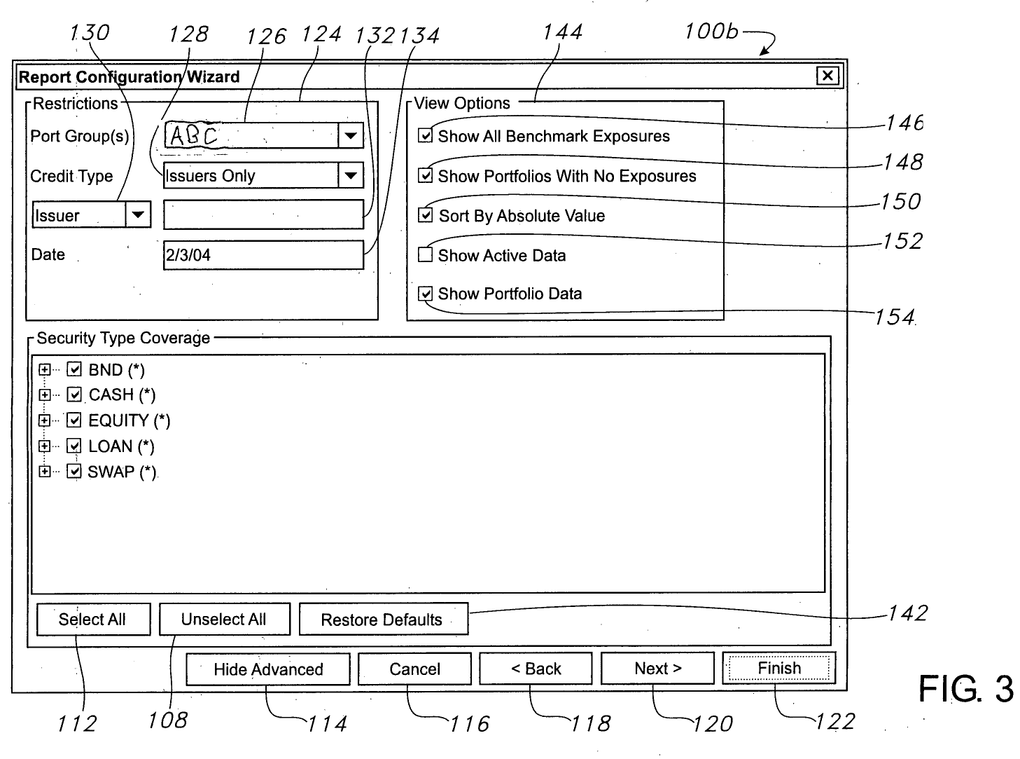

FIGS. 2-16 illustrate examples of graphical user interface screens (hereinafter also referred to as “screens”) configured in accordance with a preferred embodiment of the subject invention. The screens are identified generally by reference numerals as described herein and shown in the figures. As shown in FIGS. 2 and 3, screens 100a and 100b provide various menus and data entry fields (hereinafter also referred to as “fields”), which can be integrated with a system, such as system 10. Screens 100a and 100b are generally configuration interfaces for, among other things, configuring the exposure analysis across portfolios in a portfolio group and the presentation of data helpful for optimizing the diversification of investments therein. The screens shown herein will be discussed in conjunction with the exemplary settings and analysis displayed thereon as a non-limiting example of an embodiment of the present invention for the purpose of illustrating features thereof.

Screen 100a includes a “Quick Picks” menu 102 that provides the portfolio manager with quick access to preset, and preferably, the most often utilized, rule or configurations for system 10 to follow to categorize, group or otherwise classify the investments (hereinafter referred to as a “rule”) in generating reports that illustrate exposure. Depending on the rule selected, system 10 uses the investment data in portfolio database 16 to group the investments by the common attribute associated with the particular rule. For example, if the selected rule requires categorizing the investments by issuer, then system 10 will analyze the investment data to determine the issuer for each investment and group the investments accordingly.

Menu 102 also includes the option to create a custom exposure report using configurations or rules other than those included as “Quick Picks.” The “Custom” option is shown as being selected for the exemplary analysis of this embodiment. Menu 102 includes 1) Issuer by Portfolio Group Tree, 2) Lehman Bros. Holdings Inc. (LEH) Sector and Issuer by Portfolio Group Tree, 3) Credit Type and Issuer by Portfolio Group Tree, and 4) Currency and Issuer by Portfolio Group Tree.

A “Value(s)” menu 104 on screen 100a provides the portfolio manager with the option to select the parameter that system 10 will use to quantify the exposure of investments in each category, depending on the chosen rule for categorization. As shown in this embodiment, menu 104 is pre-populated with industry standard comparative parameters, such as Market Value, % NAV, % Duration, % Benchmark Duration, Duration Dollar, Duration Contribution, Convexity Dollar, etc., but also preferably includes the option to create a customized calculable parameter.

For example, selecting “Issuer by Portgroup Tree” in menu 102, and “Market Value” in menu 104 would result in system 10 categorizing the investments by issuer, and for each category, quantifying the exposure by determining the total market value of all investments which can be included therein. If % NAV was selected as the comparative parameter, system 10 would determine the % NAV for the investments in each issuer category. The portfolio manager can use parameters such as market value or % NAV to evaluate and compare exposure to each category of investment.

If the “Custom” option in menu 102 is selected, as is this case in the exemplary analysis, the portfolio manager is provided with the opportunity to customize the exposure evaluation, including the rule used to categorize the investments and presentation of the resulting graphs, charts, and/or tables used to facilitate the exposure evaluation. Menu 106 permits the portfolio manager to select the rule by manipulating the side and top axes for the graphs, charts, and/or tables from “Available Axes” menu 106. Axes that are selected from menu 106 to be the side axes are moved from menu 106 to “Side Axes” field 108. Similarly, axes selected from menu 106 to be the top axes in the graphs appear in “Top Axes” field 110 upon selection. The selected arrangement of the report is shown in “Report:” field 112 on screen 100a.

In the exemplary analysis, the side axes include “Currency”, “Sec. Type”, “LEH Sector” and “Issuer,” as shown in field 108, and the top axis is “Portgroup Tree,” as shown in field 110. The exemplary analysis is configured as entitled in field 112, namely “Currency & Sec. Type & LEH Sector & Issuer by Portgroup Tree.” Thus, a multi-part rule for categorizing and evaluating the investments has been designated in the exemplary analysis in which the investments of the selected portfolio group will be categorized by currency, sector type (using the LEH sector classifications) and issuer for the portfolio group by individual portfolios.

A “Hide Advanced” button 114 controls the display of advanced settings and features, “Cancel” button 116 cancels any settings to allow a new report configuration to be entered, “<Back” and “Next>” buttons 118 and 120 allow the portfolio manager to toggle between screens 100a and 100b (discussed in further detail below). The “Finish” button 122 instructs system 10 that the report configuration is complete. Preferably, selecting finish button 122 actuates the exposure analysis.

Screen 100b provides further report configuration options for the exposure analysis. Restrictions to the analysis can be set in “Restrictions” menu 124. Menu 124 includes a “Port Group” field 126 for selecting the portfolio group for evaluation. The portfolio group can be a predefined group having a logical composition of investment portfolios, for example, a group of portfolios under management by a specific portfolio manager, or a group of portfolios owned by a particular individual or institutional investor. Alternatively, a group of portfolios can be specified or created by directly entering individual portfolio names in field 126. In the exemplary analysis, the portfolio groups are predefined and the group referred to as “ABC” is selected. Thus, system 10 would search portfolio database 16 for all portfolios associated with the ABC group for inclusion in the exposure evaluation.

Menu 124 also enables a portfolio manager to designate the credit types included for evaluation in “Credit Type” field 128. The portfolio manager can specify the credit type further in drop down menu 130, which contains a predefined list of particular credit types relating to the credit type chosen in field 128, and/or data entry field 132, which allows the portfolio manager to enter specific data related to the entry in credit type field 128.

In the exemplary analysis, “Issuers Only” is selected as the credit type in field 128, and “Issuer” is displayed in field 130, however, “Underlier” or “Enhancer,” among other specifications may also be selected. Although none is specified in the exemplary analysis, the portfolio manager could specify an issuer or group of issuers in field 132 if desired. For example, individual issuers may be specified by ticker symbol (e.g., F as the current ticker symbol for Ford Motor Company), or a group of issuers may be selected by entering a group name. Groups of issuers can be related to one another based on some exogenous criteria, such as, for example, membership in a particular industry sector (e.g., banking, automotive, aerospace, etc.) or by an arbitrary designation, such as a best or worst contributors list, or a top ten largest holdings list. In the embodiment shown, credit types with issuers only would be included in the exposure analysis.

Menu 124 further includes a “Date” data entry field 134 for specifying the date on which the exposure analysis is to be based. For example, exposure across a selected group of investment portfolios can be evaluated based upon current market data, positions and risk as of the end of the previous trading day or historical market data maintained in database 18. Market data may be supplied from an outside source by way of a real-time or near real-time data feed, or market data may be compiled and stored in memory in a more conventional manner. The exemplary analysis is based on the data from Feb. 3, 2004, as shown in field 134.

In “Security Type Coverage” menu 136, various security types may be selected for inclusion in the exposure analysis. Bonds, cash, equity, loan and swap are displayed as class headings and can be expanded (not shown) to display specific class members in hierarchal order for specification by the portfolio manager. In the exemplary analysis, all class headings are checked for inclusion in the evaluation. Options are provided to the portfolio manager via the select all button 138, unselect all button 140, and restore the default settings button 142 to facilitate the selection process.

A “View Options” menu 144 in screen 100b provides the portfolio manager with the opportunity to customize the manner in which the results of the analysis will be displayed to the portfolio manager in the form of charts, graphs and/or tables via graphical interfaces 12 by checking the appropriate box. In particular, the “Show All Benchmark Exposures” box 146 in menu 144 can be used to reveal the absolute exposure values of a selected benchmark portfolio having undergone the same analysis as the selected portfolio. Also, a “Show Portfolios With No Exposures” box 148 includes the portfolios with no quantifiable exposure in the analysis results. A “Sort By Absolute Value” box 150 effects the order of the results. A “Show Active Data” box 152 provides the relative exposure values, that is, the difference in exposure values between the selected portfolio and the benchmark portfolio, in the results. A “Show Portfolio Data” box 154, provides the absolute exposure values relating to the selected portfolio.

In the configuration depicted in Screen 100b, the Show Portfolios with Benchmark Exposures box 146, Show Portfolios with No Exposures box 148, Sort by Absolute Value box 150 and Show Portfolio Data box 154 have all been selected, while the Show Active Data 152 box has not been selected for this exemplary analysis.

Screen 100b also includes a Hide Advanced button 114, Cancel button 116, <Back button 118, Next> button 120, and Finish button 122, as described above with regard to screen 100a. Selecting the Finish 122 button initiates an exposure analysis according to the designated settings.

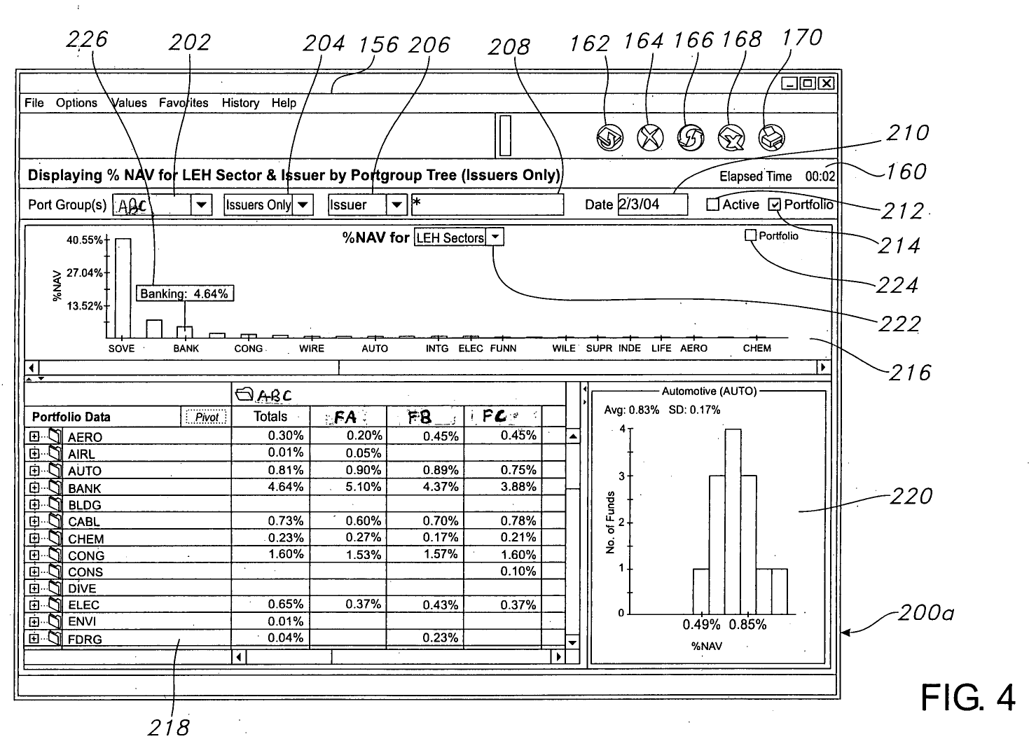

FIGS. 4-16 provide non-limiting examples of screens that present the results of exposure analyses and allow for further configuration, among other things, in accordance with the present embodiment. Each of the screens shown in FIGS. 4-16 (collectively referred to as “the presentation screens”) possesses certain common aspects, functions and features to facilitate operation and increase familiarity with the system, among other things.

For example, a menu bar 156 is included on the presentation screens that includes drop down menus with various options for, among other things, re-sorting or changing the view or values, saving/printing the results and exporting the results. Menu bar 156 options are accessible by clicking on the “File,” “Options,” “Values,” “Favorites,” “History” and “Help” links of bar 156, which result in the appearance of further menus containing logically related options. The presentation screens also include a title bar 158 that provides a description of the displayed results and an elapsed time indicator 160 that displays the computational time system 10 required to the perform the analysis.

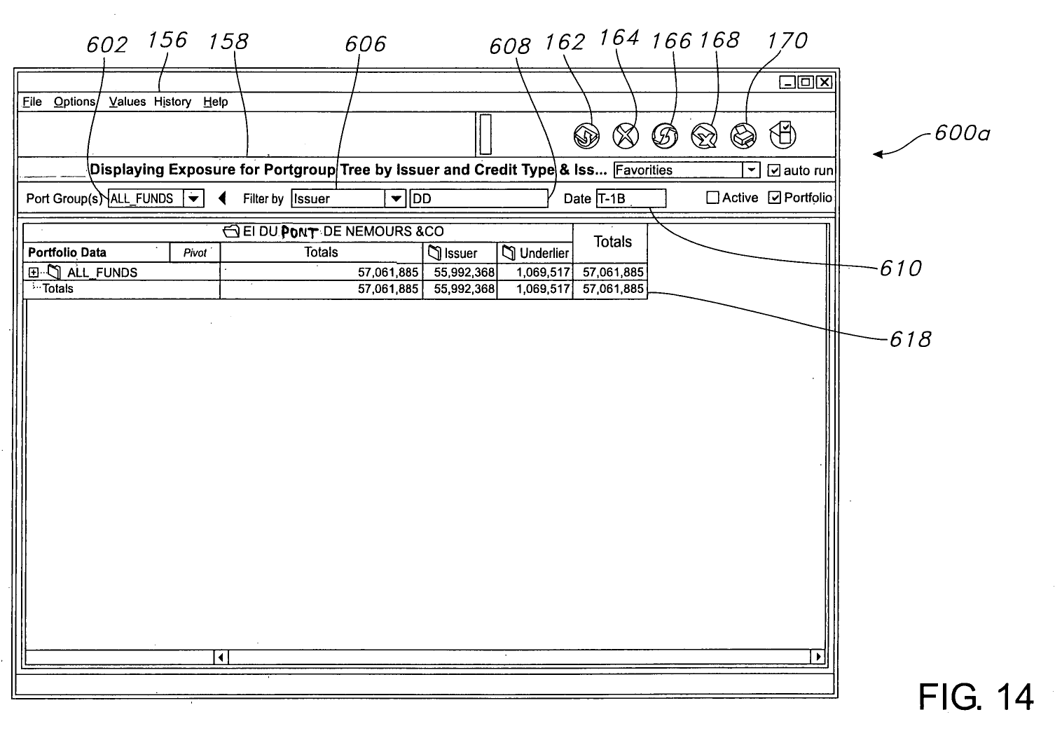

Preferably, and as shown in this embodiment of the present invention, the presentation screens include shortcut buttons that provide quick access to specific functions and options. These options and functions may also be accessed through the drop down menus in menu bar 156. The shortcut buttons in the presentation screens of this embodiment include a return button 162 for returning to configuration screens 100a and 100b, a save button 164 for saving the results to memory in a portable media or local hard drive, an e-mail button 166 for automatically sending the results as a web link via electronic mail (as shown in the screen of FIG. 14 and discussed in further detail below), an export button 168 for exporting the results to Microsoft Excel or similar program containing spreadsheets and mathematical functionability, and a print button 170 for printing the results to a local or network printer.

### EXAMPLE 1

Screens 200a, 200b and 200c of FIGS. 4-6 are illustrative screens for displaying the results of an exemplary analysis in the form of interactive graphs, charts and tables, which was configured in screens 100a-b described above. The results are described as “Displaying % NAV for LEH Sector & Issuer by Portgroup Tree (Issuers Only)” in title bar 158 in screens 200a-c.

The rule for categorization which would be configured in screens 100a-b for this exemplary analysis is that system 10 is to categorize investments of issuers only within the ABC portfolio group stored in portfolio database 16 by LEH sector, and also, subcategorize these investments by issuer for each portfolio in the portfolio group, and the entire portfolio. The comparative parameter is % NAV, and therefore exposure is quantified by calculating the total % NAV values for the investments in each category and subcategory for each portfolio within the portfolio group. Further details regarding inputting this rule and the output results are discussed below.

This exposure analysis was partially configured by selecting “Custom” in menu 102 of screen 100a. The comparative parameter was set by selecting “% NAV” in value menu 104 of screen 100a. The categories were defined in screen 100a by selecting “LEH Sector” and then “Issuer” from available axes menu 106 for side axes menu 108, and selecting “Portgroup Tree” from available axes menu 106 for top axes menu 110. These settings in screen 100a instructed system 10 to analyze the investments stored in databases 16 and 18, which contain data about the portfolios and investments. The data in databases 16 and 18 include descriptive information about each investment, such as its type, issuer, class, sector, industry, etc., which is referred to as its attributes. System 10 categorizes the investments of the selected portfolio group (ABC) by matching those investments that have common attributes according to the selected rule, that is, in this example, are of the same portfolio, LEH sector and issuer.

In addition, system 10 was instructed by the settings in screen 100a to determine the % NAV of the investments in each category and subcategory for each portfolio in the portfolio group, and the % NAV of the investments in each category and subcategory for the entire portfolio group. In this example, the categories are portfolio and LEH sector, with issuer as a subcategory of LEH sector. The remaining configuration for this analysis was set in screen 100b. The portfolio group was set by selecting “ABC” in Port Group field 126 of restrictions menu 124. The “Issuers only” restriction was set in Credit Type field 128. The date was set in field 134. The view options were set in menu 144 and the security type coverage was set in field 136.

Screens 200a-c were generated by clicking finish button 122 in either screen 100a or 100b. Screens 200a-c include some of the same data from screens 100a-b. The portfolio group involved in the analysis, the ABC group, is listed in a “Port Group” field 202 of screens 200a-c, which would be the same group selected in menu 124 of screen 100b. In this embodiment another group may be selected by accessing the drop down menu associated with field 202, which would result in system 10 rerunning the same analysis on a different portfolio group.

Field 204 shows any restriction to the rule which were set in screen 100b, which in the exemplary analysis is that the investments be those of issuers only, thus “Issuers Only” is listed in field 204. The restriction may be changed using the drop down menu associated with field 204 in screens 200a-c and the analysis rerun accordingly. Drop down menu field 206 allows for further restriction, if applicable. In the exemplary analysis, the issuers only restriction can be further restricted so that only investments of a particular issuer are included in the exposure analysis. If this modification is desired, a code or name having the desired effect can be entered into adjacent field 208 of screens 200a-c.

Date field 210 displays the date on which any time-sensitive data was derived. This should correspond with the date chosen in menu 124 of screen 100b, but can be changed in field 210 of screens 200a-c, and the analysis rerun accordingly. The active display option box 212 and portfolio display option box 214 allow the portfolio manager to view active data, absolute exposure values for the portfolio, or both, as described above, in the graphs, charts and tables shown in screen 200a-c. In the exemplary analysis, the portfolio option box 214 is checked while the active display option box 212 is not checked. These settings would reflect corresponding check boxes 152 and 154 in screen 100b.

The results of the exposure analysis are displayed for the selected group in a distribution chart section 216, a corresponding spreadsheet section 218, and an attribute specific detail distribution chart section 220, (e.g., by sector, issuer, security, etc.). Sections 216, 218 and 220 are preferably interactive and responsive to computer based stimuli, in that the display of information will change and provide additional or further details by detectable actions, such as placing the cursor (i.e., in response to movement of the mouse by the portfolio manager) over the columns in chart sections 216 and 220 of screens 200a-c, or on the graphical representations of folders in spreadsheet section 220.

Chart section 216 illustrates a distribution chart with the comparative parameter as the y-axis and the categories or subcategories on the x-axis. The categories may be adjusted to show exposure values based on one of the other categories or subcategories selected in the configuration screens 100a-b through drop down menu 222. Therefore, in the exemplary analysis, the distribution chart in section 216 can be either % NAV versus the ABC group categorized into LEH sectors, % NAV versus the ABC group categorized by issuer, or % NAV versus the portfolio group tree, that is, the individual portfolios. The LEH sectors are sorted by absolute value, which is the result of checking checkbox 150 of screen 100b. Chart section 216 can be changed to illustrate the comparative parameter versus the portfolios in the selected group by selecting portfolio button 224, which in the exemplary analysis, would be % NAV versus portfolios in the ABC group.

Section 218 includes a spreadsheet, which is in tabular format and defines individual cells associated with columns and rows. In the exemplary analysis, each column represents one portfolio in the selected portfolio group ABC (e.g., “FA,” “FB,” “FC,” etc.) or the total for the ABC group. Each row of the spreadsheet represents one category of the selected LEH sector categories (e.g., “AERO,” “AUTO,” “BANK,” etc.) or the total for portofolio. Thus, each cell contains an exposure value in terms of the comparative parameter, which in this analysis is % NAV.

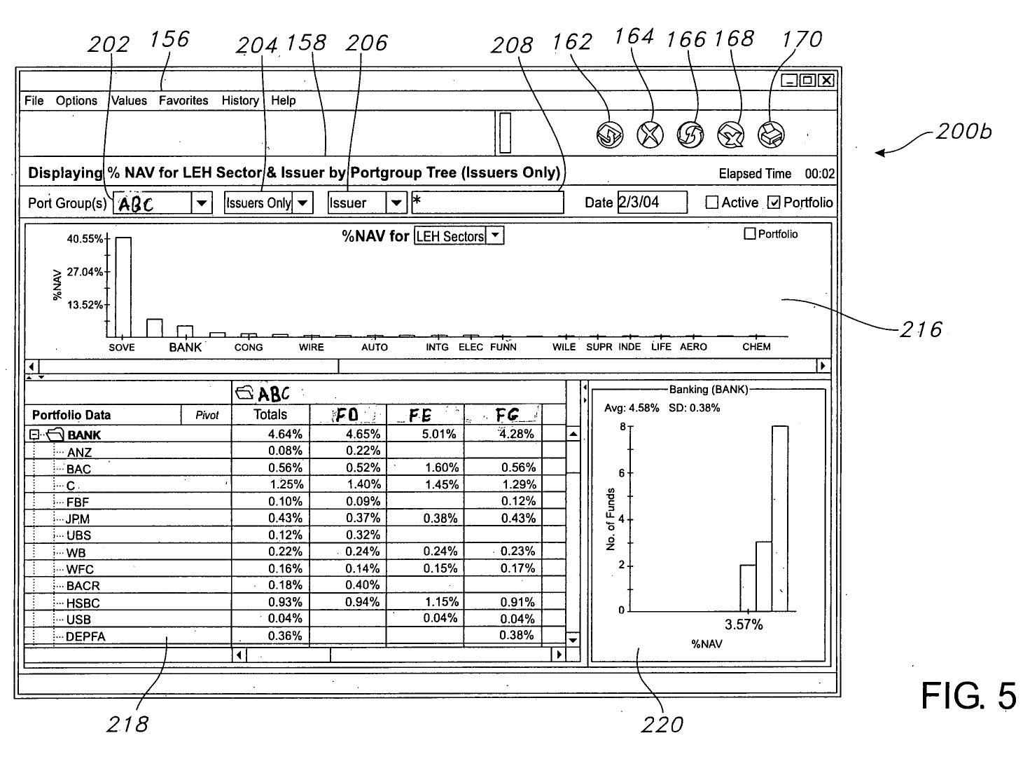

The categorized information in the spreadsheet of section 218 is listed in alphabetical order and in a hierarchal format (i.e., “file folders” pictographs commonly used in Microsoft Windows® Explorer) for further delineation and detailed examination. Each category is represented by a folder which can be opened by clicking thereon, or by some other computer-based stimuli, to reveal a list of subcategories in further rows along with exposure values in terms of the comparative parameter for each of the portfolios in the selected portfolio group. For example, in screen 200b (FIG. 5), the “Bank” sector has been expanded to show its subcategories, which consists of investments that are categorized in the banking sector further categorized by issuer. In addition, the subcategories are associated with exposure values calculated in terms of % NAV that show the breakdown of exposures by issuer within the banking sector and illustrate the exposure by issuer in the banking sector for each portfolio in the ABC group.

The cells without numbers in the section 218 spreadsheet, such as those associated with the “BLDG” sector, correspond with portfolios that have no exposure to investments in the corresponding category. These cells are included in the results because “Show Portfolios with No Exposures” checkbox 148 in screen 100b is checked.

Section 220 includes a detailed distribution bar graph wherein the x-axis is the comparative parameter % NAV and the y-axis is the number of funds (i.e., portfolios in the selected portfolio group ABC) with exposures to a particular category or subcategory of interest. The values are fit to show the relative weighting of investments of a particular category across the portfolio, among other things, and the portfolio manager is provided with an average value and standard deviation between groupings represented by the bars on the graph.

In screen 200a (FIG. 4), the “Auto” sector is the category of interest, therefore, section 220 includes a bar graph having the % NAV values from 13 portfolios within the ABC group that include investments which yield exposure to the automotive sector. The standard deviation is 0.17%, and the average is 0.83%, which reveals that the relative weighting of these investments is almost even across the portfolios in the group.

As shown in screen 200a, moving the cursor over a bar in the graph of section 216 actuates a pop-up detail display 226 which provides detailed information about the value represented by the selected bar. In this example, the bank sector bar graph represents a % NAV of 4.64%, which is the absolute exposure value and corresponds with the exposure value in the total column and bank sector row of spreadsheet 218. The pop-up detail display 226 may also be actuated by other computer-based stimuli.

System 10 calculates exposure values for each category and subcategory, if any. In this analysis, each of the LEH sectors contain investments which are further categorized in subcategories by issuer (e.g., within the Bank sector category is HSBC, JPM, etc.), for which system 10 has calculated exposure values, as shown in screen 200b. The subcategories are arranged as a hierarchal tree under the LEH sectors, and can be accessed to reveal the exposure values due to investments associated with a particular issuer by clicking on the plus sign adjacent the folders and LEH sector titles in the spreadsheet in section 218. In screen 200b (FIG. 5), the “Bank” sector in spreadsheet section 218 is selected to reveal its issuer-based subclasses and associated % NAV values for the portfolios of the ABC portfolio group. Alternatively, selecting or highlighting the “Bank” column of the distribution chart in chart section 216 can also initiate the subcategory spreadsheet shown in screen 200b.

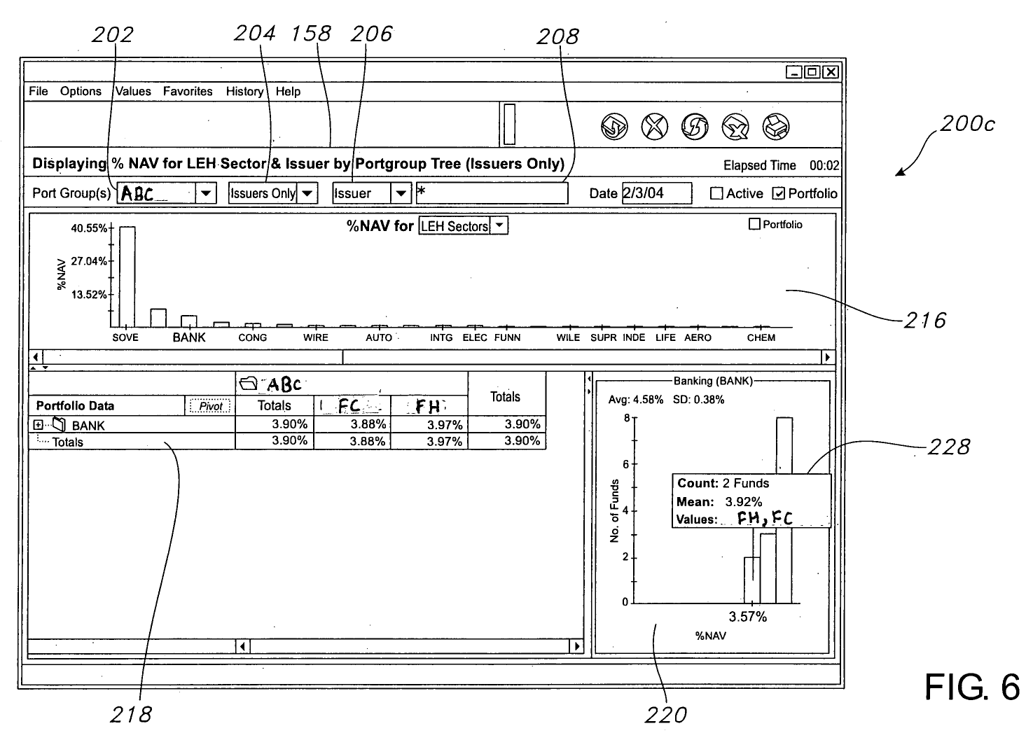

By selecting the banking sector for further examination, system 10 responds by providing the portfolio manager with a detail distribution chart for the banking sector in section 220, as shown in screens 200b and 200c. As shown in screen 200c (FIG. 6), by moving the cursor onto, or otherwise selecting a bar in the graph of section 220, a pop up detail display 228 reveals that that bar represents two funds (FH and FC) having a mean % NAV value of 3.92% for investments in the banking sector. As also shown in screen 200c, the interactive features of system 10 also provide the portfolio manager with a spreadsheet in section 218 that provides information only about the two funds highlighted by the bar and described by pop up detail display 228.

Although it is not shown in the example, the portfolio manager can view the exposure values, as quantified for the portfolio manager's review in this analysis by % NAV, for each LEH sector category and the issuer subcategories for each LEH sector category on portfolio group scale in section 216, in a spreadsheet in section 218, and per LEH sector category in section 220. In addition, the “Pivot” button in section 218 provides the portfolio manager with the ability to pivot the axes, that is, rearrange the display in sections 216, 218 and 220, if desired, by switching the x-axis and y-axis values and plotting the data accordingly.

### EXAMPLE 2

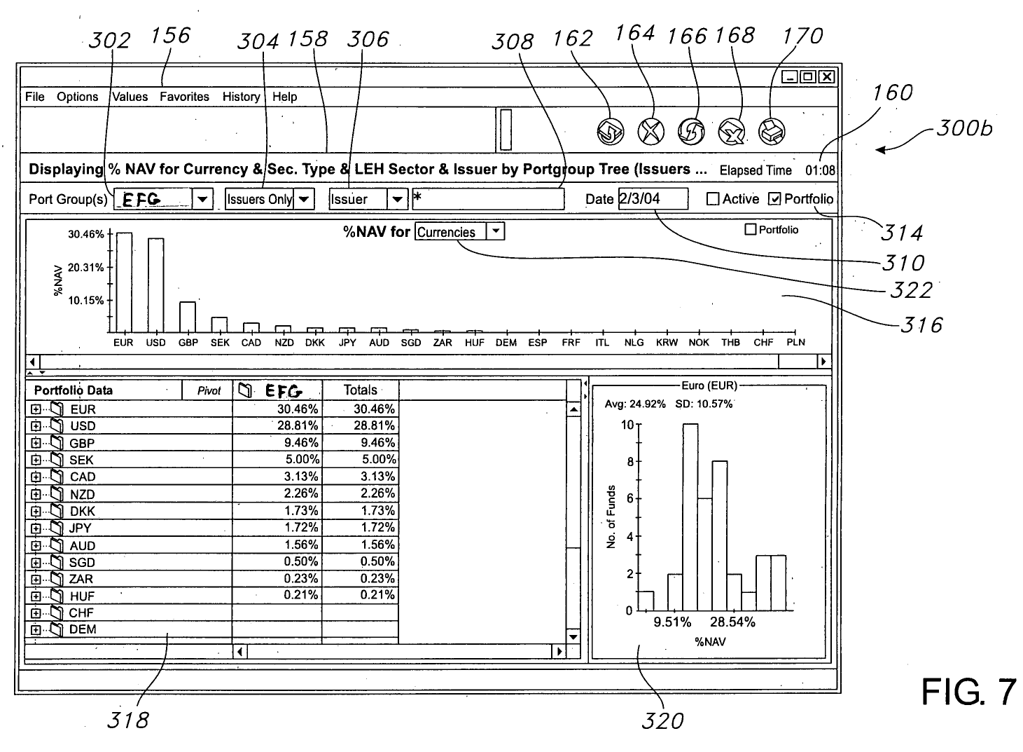

Screens 300a, 300b, 300c and 300d of FIGS. 7-10 are illustrative screens for displaying the results of another exemplary analysis in the form of interactive graphs, charts and tables, which was configured in screens 100a-b. The results are described as “Displaying % NAV for Currency & Sec. Type & LEH Sector & Issuer by Portgroup Tree (Issuers Only)” in title bar 158 in screens 300a-d.

The rule for categorization which would be configured in screens 100a-b for this exemplary analysis is that system 10 is to categorize investments of issuers only within the EFG portfolio group stored in portfolio database 16 by currency, and also, subcategorize these investments by security type, subcategorize each of those categories by LEH sector, and subcategorize each of those categories by issuer for each portfolio in the portfolio group, and the entire portfolio. The comparative parameter is % NAV, and therefore exposure is quantified by calculating the total % NAV values for the investments in each category and subcategory for each portfolio within the portfolio group, and for the entire portfolio group. Further details regarding inputting this rule and the output results are discussed below.

This exposure analysis was partially configured by selecting “Custom” in menu 102 of screen 100a. The comparative parameter was set by selecting “% NAV” in value menu 104 of screen 100a. The categories were defined in screen 100a by selecting “Currency” and then “Sec. Type,” “LEH Sector” and “Issuer” from available axes menu 106 for side axes menu 108, and selecting “Portgroup Tree” from available axes menu 106 for top axes menu 110. These settings in screen 100a instructed system 10 to analyze the investments in portfolio database 16 and categorize the investments of group EFG by matching those investments by common attribute. In this example, the attributes sought related to currency, security type, LEH sector, issuer and portfolio.

In addition, system 10 was instructed by the settings in screen 100a to determine the % NAV of the investments in each category and subcategory for each portfolio in the portfolio group, and the % NAV of the investments in each category and subcategory for the entire portfolio group. The remaining configuration for this analysis was set in screen 100b. The portfolio group was set by selecting “EFG” in Port Group field 126 of restrictions menu 124. The “Issuers only” restriction was set in Credit Type field 128. The date was set in field 134. The view options were set in menu 144 and the security type coverage was set in field 136, as in the previous example.

Screens 300a-d were generated by clicking finish button 122 in either screen 100a or 10b. Screens 300a-d include some of the same data from screens 100a-b. The portfolio group involved in the analysis, the EFG group, is listed in a “Port Group” field 302 of screens 300a-d, which would be the same group selected in menu 124 of screen 100b.

Field 304 shows any restriction to the rule which were set in screen 100b, which in the exemplary analysis is that the investments be those of issuers only, thus “Issuers Only” is listed in field 304. Date field 310 displays the date on which any time-sensitive data was derived. This should correspond with the date chosen in menu 124 of screen 100b. In this exemplary analysis, portfolio option box 314 is checked while the active display option box 312 is not checked. These settings would reflect corresponding check boxes 152 and 154 in screen 100b.

The results of the exposure analysis are displayed for the selected group in distribution chart section 316, spreadsheet section 318, and category detail distribution chart section 320. Chart section 316 illustrates a distribution chart with the comparative parameter % NAV as the y-axis and the currency categories on the x-axis. The weighting of each currency represented in the GLOB_AGG portfolio is displayed in order of highest to lowest % NAV values. The values represented by the bars in section 316 correspond to the total values displayed in the section 318 spreadsheet. For example, the “EUR” bar in section 316 corresponds with a % NAV of 30.46%, and the same is shown in the “EUR” row of the spreadsheet in section 318. In the exemplary analysis, the distribution chart in section 316 can be adjusted by field 322 to illustrate % NAV versus the EFG group categorized by currency, security type, LEH sector, issuer or portfolio group.

In the exemplary analysis, the categorized information in the spreadsheet of section 318 is listed in alphabetical order and in a hierarchal format for further delineation and detailed examination, as in the previous example. System 10 has analyzed the portfolio and investment data in portfolio database 16 to match common attributes in order to be able to categorize and subcategorize each investment according to the rule input into screens 100a-b as described above.

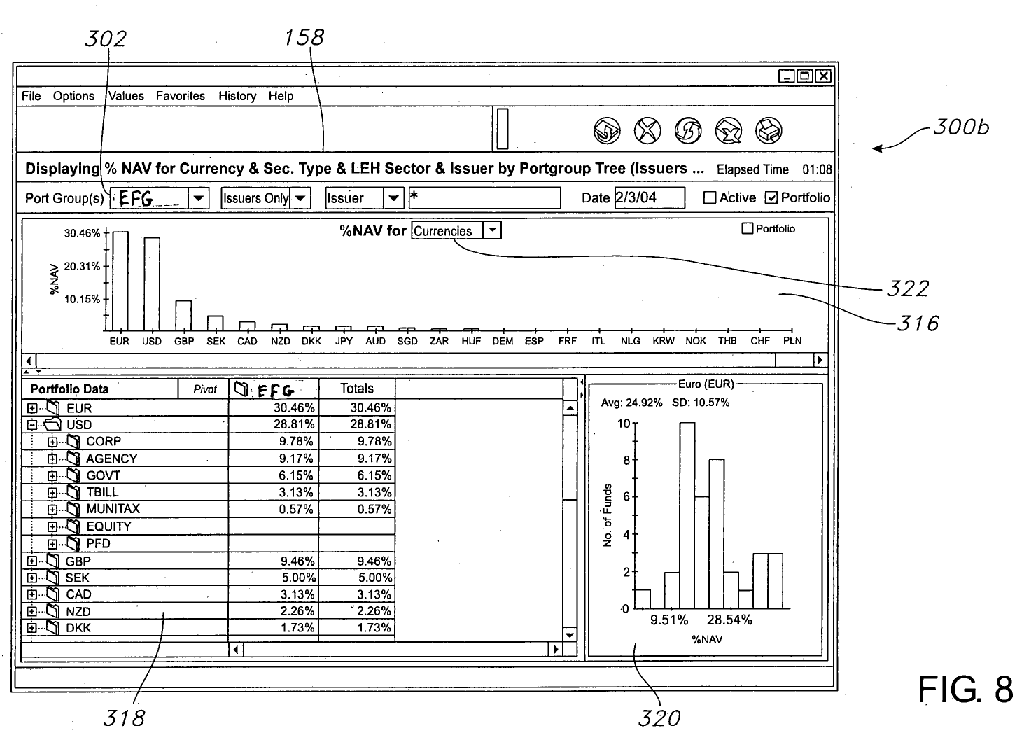

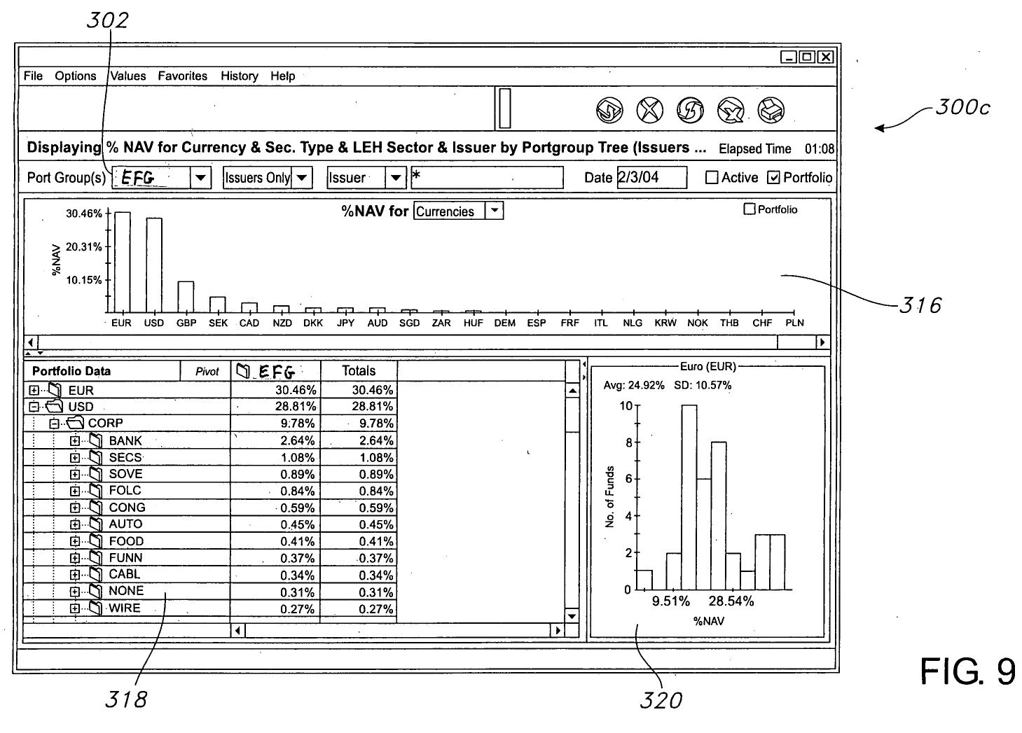

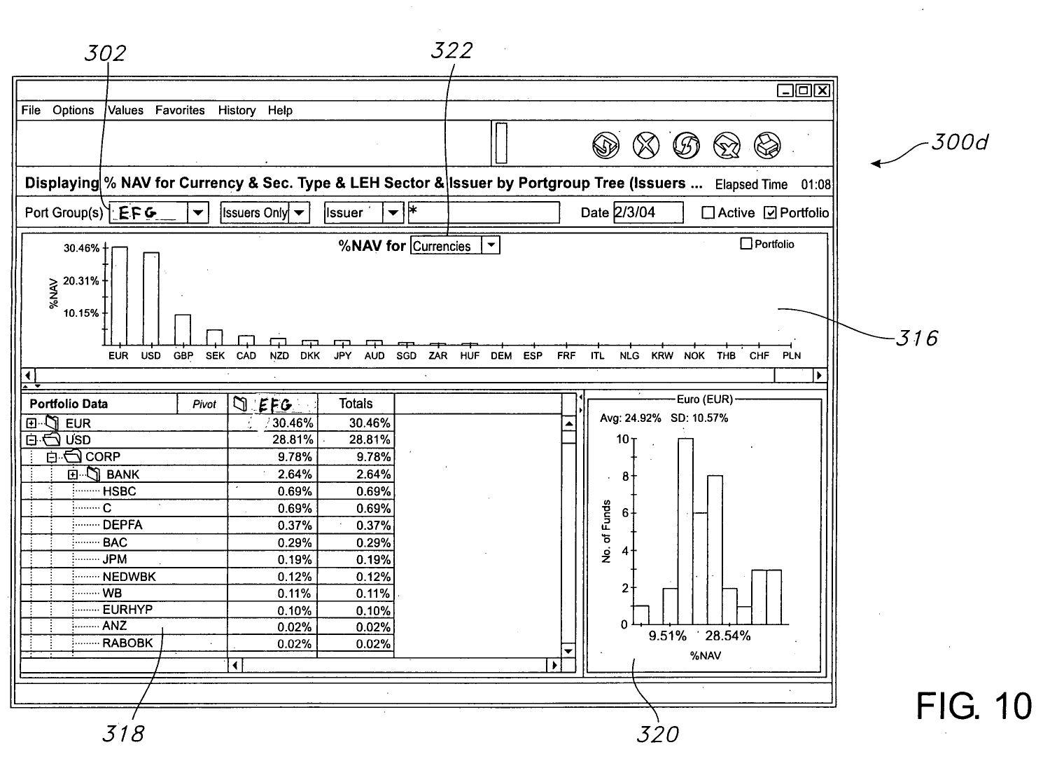

As shown in screen 300a (FIG. 7), the first level of categorization set by the rule is to group investments by common currency (e.g., “EUR,” “USD,” “GBP,” etc.), and system 10 determines the % NAV of the investments in each category. The second level of categorization is done by security type (e.g., “CORP,” “AGENCY,” “GOVT,” etc.), and system 10 calculates the % NAV for each subcategory grouping of investments under each category in the first level, as shown in screen 300b (FIG. 8). Screen 300c (FIG. 9) illustrates the third level of categorization, which is by LEH Sector. System 10 calculates the % NAV for each subcategory grouped by LEH sector under each security type subcategory. As shown in screen 300d (FIG. 10), the fourth level of categorization is by issuer, and therefore, system 10 calculates the % NAV for each subcategory grouping of issuers under each LEH sector subcategory.

The % NAV of investments in the EFG portfolio is viewable by common currencies, security types, LEH sectors, and issuers. In this exemplary analysis, the portfolio manager can evaluate exposure as it relates to issuers, and determine the possible collateral or parallel effect an issuer exposure may have on the related LEH sector, security type and currency.

### EXAMPLE 3

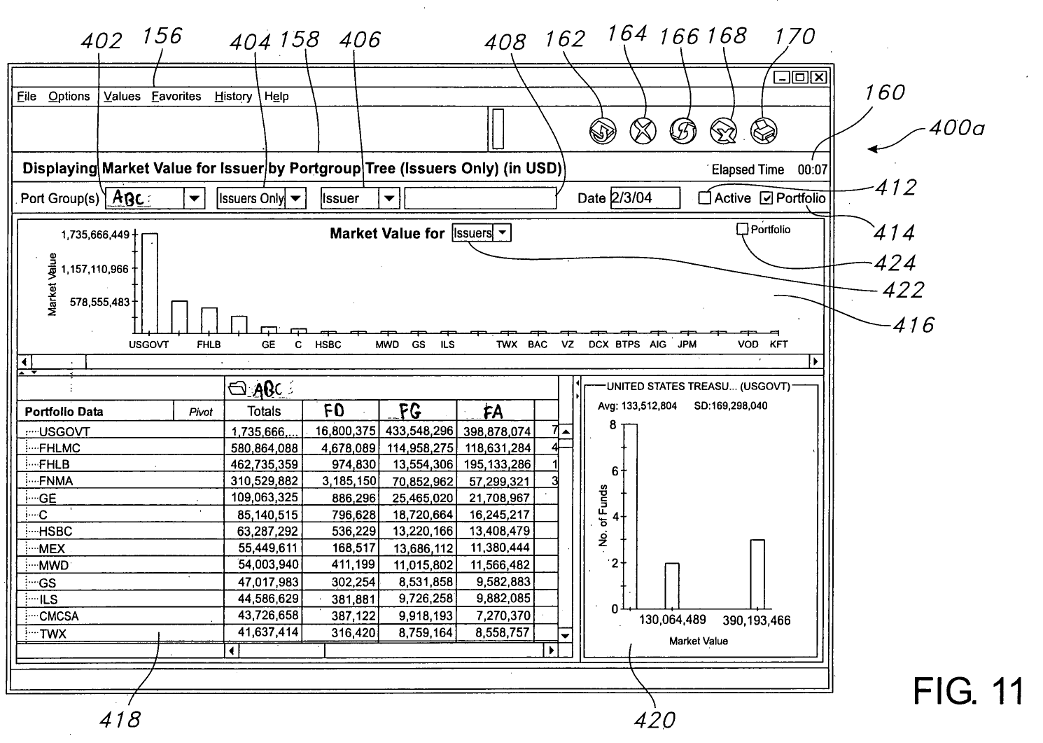

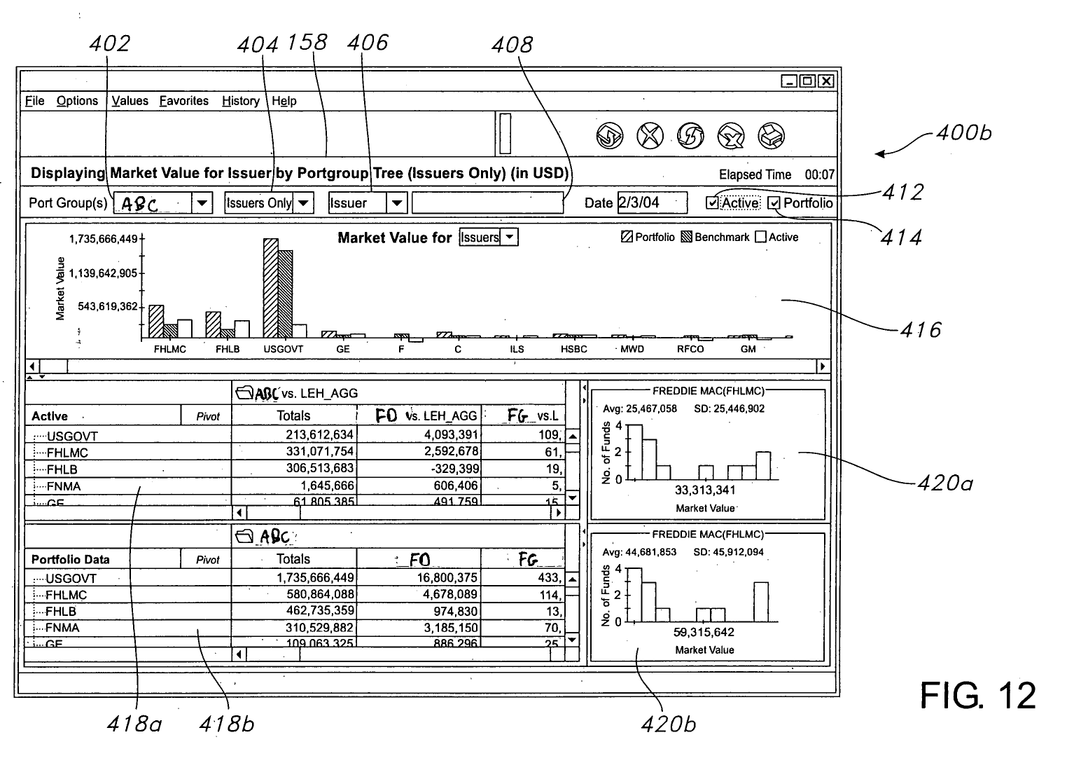

Screens 400a and 400b of FIGS. 11-12 are illustrative screens for displaying the results of another exemplary analysis in the form of interactive graphs, charts and tables, which was configured in screens 100a-b. The results are described as “Displaying Market Value for Issuer by Portgroup Tree (Issuers Only) (in USD)” in title bar 158 in screens 400a-b.

The rule for categorization that would be configured in screens 100a-b for this exemplary analysis is that system 10 is to categorize investments of issuers only within the ABC portfolio group stored in portfolio database 16 by issuer for each portfolio within the portfolio group and the entire portfolio. The comparative parameter is market value, and therefore exposure is quantified by calculating the total market value for investments in each category for each portfolio within the portfolio group, and for the entire portfolio group. Further details regarding inputting this rule and the output results are discussed below.

This exposure analysis was partially configured by selecting “Custom” in menu 102 of screen 100a. The comparative parameter was set by selecting “Market Value” in value menu 104 of screen 100a. The categories were defined in screen 100a by selecting “Issuer” from available axes menu 106 for side axes menu 108, and selecting “Portgroup Tree” from available axes menu 106 for top axes menu 110. These settings in screen 100a instructed system 10 to analyze the investments stored in database 16 and categorize the investments by matching those investments that have a common attribute, which is, in this example, the issuer and portfolio.

In addition, system 10 was instructed by the settings in screen 100a to determine the market value of the investments in each category and subcategory for each portfolio in the portfolio group, and the % NAV of the investments in each category and subcategory for the entire portfolio group. The remaining configuration for this analysis was set in screen 100b. The portfolio group was set by selecting “ABC” in Port Group field 126 of restrictions menu 124. The “Issuers only” restriction was set in Credit Type field 128. The date was set in field 134. The view options were set in menu 144 as in the previous example.

The results of the exposure analysis are displayed for the selected group in distribution chart section 416, spreadsheet section 418, and category detail distribution chart section 420. Chart section 416 in screen 400a (FIG. 11) illustrates a distribution chart with the comparative parameter market value as the y-axis and the issuers on the x-axis. Section 418 of screen 400a lists the market value of investments from each issuer for the entire ABC portfolio and for each portfolio in the ABC group. The category chart in section 420 of screen 400a illustrates the relative weighting in the portfolios with investments falling in the “USGOVT” category across the ABC group.

In this exemplary analysis, active check box 412, which was unchecked in screen 400a, is checked in screen 400b (FIG. 12). The resulting output display includes information, in the form of charts, graphs and tables, relating to the benchmark portfolio and difference in exposures between the benchmark portfolio and selected portfolio group. The particular benchmark portfolio used by system 10 can be customized, set by the portfolio manager, or included in the portfolio data stored in portfolio database 16 as a requirement set by the portfolio owner for example.

System 10 employs the rule, requirements and restrictions set in configuration screens 100a and 100b to categorize and quantify exposure for the benchmark portfolio according to the same settings used for the selected portfolio. System 10 then calculates the difference between the benchmark portfolio values and the selected portfolio values. The resulting data output is preferably arranged adjacently or in split-sections of the screen, using shading, coloring, titles or otherwise indications of whether the data relates to the selected portfolio, benchmark portfolio, or difference between the selected portfolio and benchmark portfolio.

Screen 400b (FIG. 11) provides an example of the manner in which this data can be illustrated to a portfolio manager in accordance with the present invention. The benchmark portfolio is LEH_AGG, and system 10 has categorized its investments by issuer and determined the market value for each category. Chart section 416 in screen 400b illustrates a distribution chart with the comparative parameter market value as the y-axis and the issuers on the x-axis. For each issuer category there is a bar representing the ABC portfolio, the benchmark portfolio and the difference in market values between the investments in the ABC and benchmark portfolios. The three bars are adjacent but include distinctive markings which is keyed to a legend included in section 416 of screen 400b. Section 418 of screen 400b is split into two sections 418a and 418b.

Section 418a provides a spreadsheet with values that represent the difference in market value between the ABC portfolio group and LEH_AGG portfolio per category of issuer, which is titled “ABC vs. LEH_AGG,” for the entire ABC portfolio group and each portfolio within the ABC group. Section 418b includes a spreadsheet with values that represent the market value per category of issuer for the entire ABC portfolio group and each portfolio within the ABC group.

The category chart in section 420 of screen 400b is split into to chart sections 420a and 420b. Section 420a includes a chart that illustrates the relative weighting difference in terms of the comparative parameter between the selected portfolio and the benchmark portfolio for investments in a particular category. In the example shown in screen 400b, the relative weighting difference between the ABC group and LEH_AGG portfolio in terms of market value is shown for investments falling in the “FHLMC” or Freddie Mac category. The average difference in exposure is a market value of $25,467,058 and the standard deviation is $25,446,902, which indicates an uneven and widespread relative weighting of investments in this category when comparing the portfolios. Section 420b includes a chart illustrating the relative weighting of investments in terms of the market value within the ABC portfolio group in the Freddie Mac category. Based on the chart in section 420b, the average market value of investments in the Freddie Mac category across the ABC portfolio group is $44,681,853, while the standard deviation is $45,912,094, indicating an uneven and widespread variation of investments in this category between portfolios across the ABC group.

### EXAMPLE 4

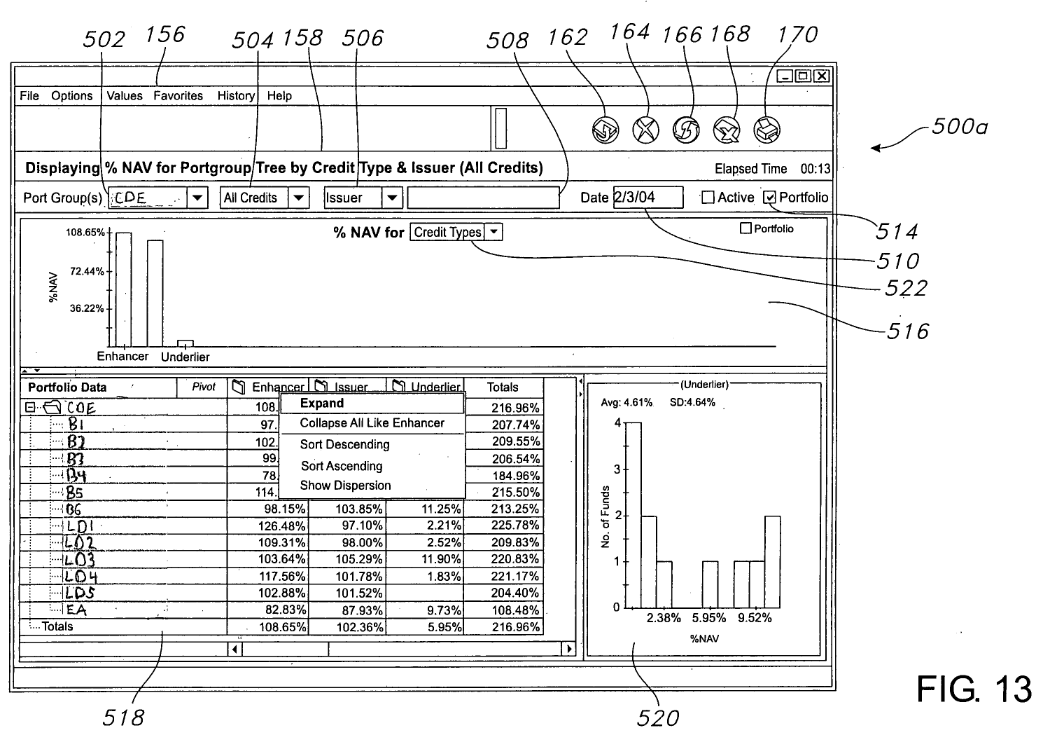

Screen 500 of FIG. 13 is an illustrative screen for displaying the results of another exemplary analysis in the form of interactive graphs, charts and tables, which was configured in screens 100a-b. The results are described as “Displaying % NAV for Portgroup Tree by Credit Type & Issuer (All Credits) in title bar 158.

The rule for categorization which would be configured in screens 100a-b for this exemplary analysis is that system 10 is to categorize investments within the CDE portfolio group stored in portfolio database 16 by portfolio for each credit type and issuer represented in the portfolio group. Thus, the order of the previous examples is reversed in that system 10 has been instructed to categorize the portfolios in groups for each credit type and issuer. The comparative parameter is % NAV, and therefore exposure is quantified by calculating the total % NAV values for the investments in each portfolio and for the entire portfolio group for each credit type and issuer in the portfolio. Further details regarding inputting this rule and the output results are discussed below.

This exposure analysis was partially configured by selecting “Custom” in menu 102 of screen 100a. The comparative parameter was set by selecting “% NAV” in value menu 104 of screen 100a. The categories were defined in screen 100a by selecting “Portgroup Tree” from available axes menu 106 for side axes menu 108, and selecting “Credit Type,” and “Issuer” from available axes menu 106 for top axes menu 110. These settings in screen 100a instructed system 10 to analyze the investments in portfolio database 16 and categorize the investments of group CDE by matching those investments by common attribute. In this example, the attributes sought related to the portfolios, credit types and issuers.

In addition, system 10 was instructed by the settings in screen 100a to determine the % NAV of the investments in each category and subcategory for each portfolio in the portfolio group, and the % NAV of the investments in each category and subcategory for the entire portfolio group. In this example, the categories are portfolio, credit type and issuer, with no subcategories. The remaining configuration for this analysis was set in screen 100b. The portfolio group was set by selecting “CDE” in Port Group field 126 of restrictions menu 124. The date was set in field 134. The view options were set in menu 144 and the security type coverage was set in field 136, as in the first example.

The results of the exposure analysis are displayed for the selected group in distribution chart section 516, spreadsheet section 518, and category detail distribution chart section 520. Chart section 516 illustrates a distribution chart with the comparative parameter % NAV as the y-axis and the credit types on the x-axis because “Credit types” is selected in field 522. In the exemplary analysis, the distribution chart in section 516 can be adjusted by field 522 to illustrate % NAV versus the CDE group categorized by portfolio or issuer also.

Due to the arrangement of the axes in configuration screens 100a-b, section 518 includes a spreadsheet with the portfolios in the CDE group listed in the rows, and the credit types (e.g., enhancer and underlier) listed in the columns along with a cumulative issuer column. Preferably, the issuer column may be further divided into columns for each individual issuer. Section 520 includes a chart displaying the relative weighting of underliers across the portfolios, by clicking on, highlighting or otherwise selecting the underlier column.

In this exemplary analysis, the portfolio manager can evaluate exposure in each portfolio as it relates to credit types and issuers, and determine the effect an issuer or credit type exposure may have on the portfolios and CDE group.

### EXAMPLE 5

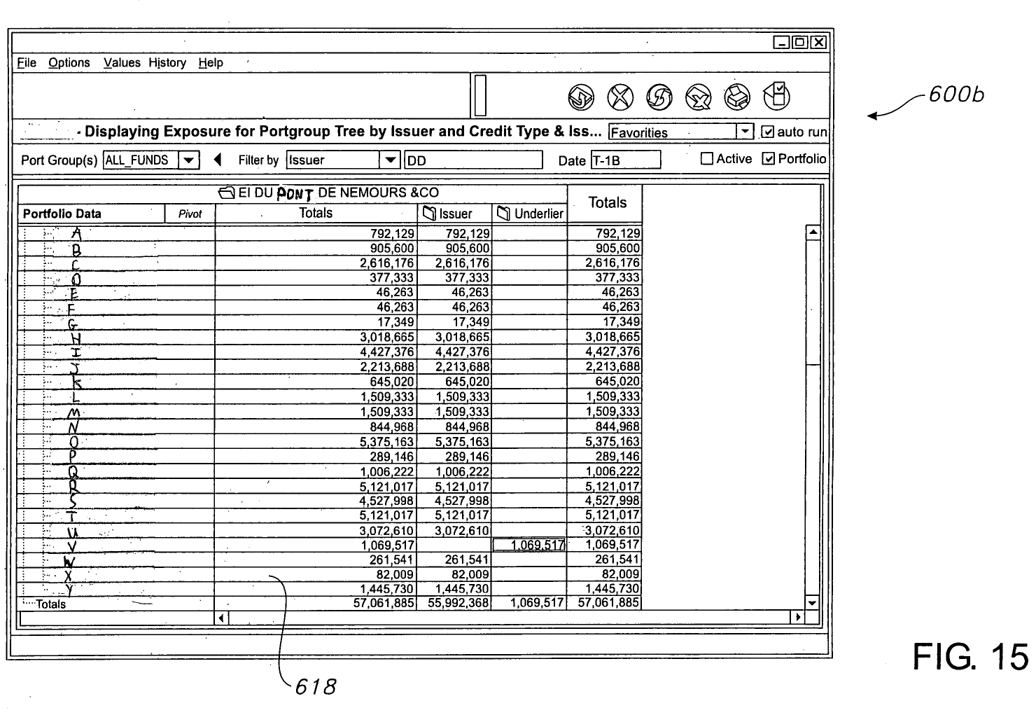

Screens 600a and 600b of FIGS. 14 and 15 are illustrative screens for displaying the results of another exemplary analysis in the form of interactive graphs, charts and tables, which was configured in screens 100a-b, although only a spreadsheet in section 618 is viewable in this example. The results are described as “Displaying Exposure for Portgroup Tree by Ultimate Issuer & Credit Type & Issuer” in title bar 158.

The rule for categorization which would be configured in screens 100a-b for this exemplary analysis is that system 10 is to categorize investments within the ALL_FUNDS portfolio group stored in portfolio database 16 by portfolio for each ultimate issuer, credit type and issuer represented in the portfolio group. A particular issuer (i.e., “EI DUPONT DE NEMOURS & CO” or code identifying the same, was selected in field 132 of screen 100a. The comparative parameter is exposure as quantified by calculating the total dollar values of the investments in which the selected issuer, EI DUPONT DE NEMOURS & CO, is either a direct issuer or acts as a corporate underlier in each portfolio and for the entire ALL_FUNDS portfolio group.

As shown in section 618 of screen 600a, the ALL_FUNDS group of portfolios includes a total of $57,061,885 of exposure to the EI DUPONT DE NEMOURS & CO corporate family, with $55,992,368 of the total exposure coming from investments, such as bonds, issued by EI DUPONT DE NEMOURS & CO directly, and $1,069,517 of the total exposure due to investments, such as municipal bonds, for which EI DUPONT DE NEMOURS & CO is a corporate underlier.

In screen 600b, the ALL_FUNDS group has been expanded in section 618 to reveal the exposure to EI DUPONT DE NEMOURS & CO by individual portfolios within the ALL_FUNDS group. As shown in section 618, the V portfolio within the ALL_FUNDS group has the $1,069,517 of the total exposure due to investments in which EI DUPONT DE NEMOURS & CO is the underlier.

In this exemplary analysis, the portfolio manager can evaluate exposure in each portfolio or the group as a whole as it relates to investments either directly issued or investments in which EI DUPONT DE NEMOURS & CO is the underlier, or for any other issuer specified in field 132.

### EXAMPLE 6

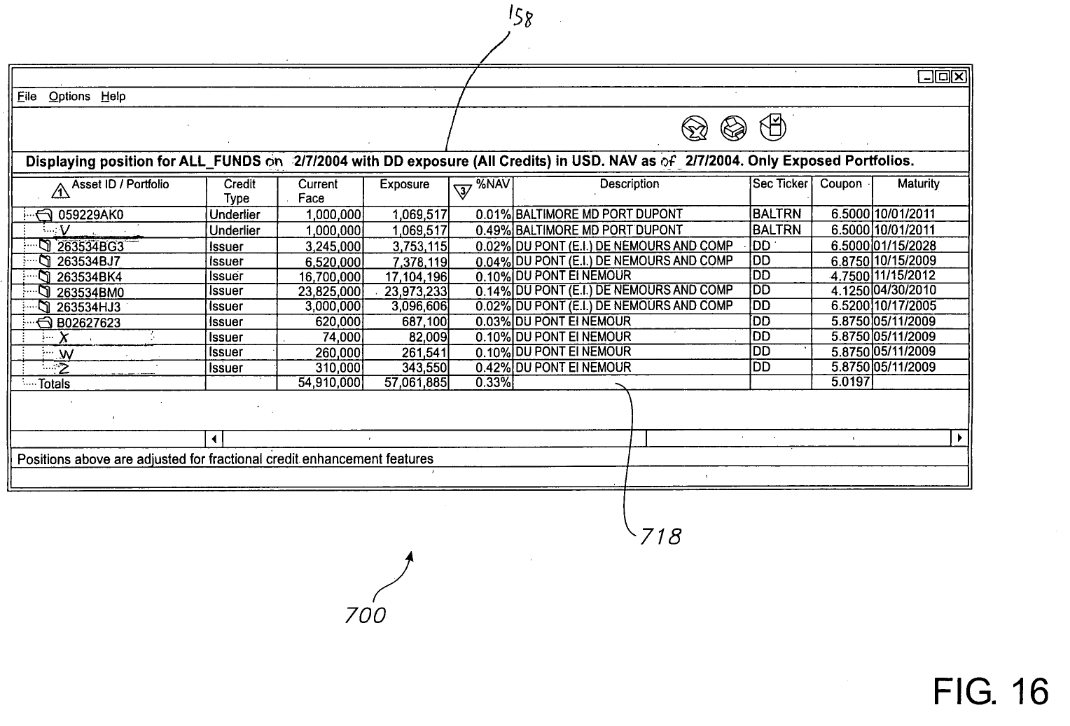

Although only a spreadsheet in section 718 is viewable in this example, screen 700 of FIG. 16 is an illustrative screen for displaying the results of another exemplary analysis in the form of interactive graphs, charts and tables, which was configured in screens 100a-b. The results are described as “Displaying Positions for ALL_FUNDS on Dec. 7, 2004 with DD exposure (ALL Credits) in USD. NAV as of Dec. 7, 2004. Only Exposed Portfolios” in title bar 158.

The rule for categorization which would be configured in screens 100a-b for this exemplary analysis is that system 10 is to categorize investments within the ALL_FUNDS portfolio group stored in portfolio database 16 by investments contributing to the exposure figures, for a specific issuer represented in the portfolio group. The particular issuer, EI DUPONT DE NEMOURS & CO was selected in field 132 of screen 100a. There are multiple comparative parameters in this example, exposure and % NAV.

As shown in section 718 of screen 700, the ALL_FUNDS group of portfolios includes a seven investments, identified by asset ID number, that are either directly issued by EI DUPONT DE NEMOURS & CO or are investments in which EI DUPONT DE NEMOURS & CO is a corporate underlier.

For example, as shown in section 718, an investment known as asset ID 059229AKO, in which EI DUPONT DE NEMOURS & CO is an underlier, has been expanded to reveal that it is present in the V portfolio. The amount of this asset in the V portfolio corresponds to a % NAV of 0.49% relative to the V portfolio, a % NAV of 0.01% relative to the ALL_FUNDS group, and exposure to EI DUPONT DE NEMOURS & CO measured as $1,069,517. Also, an investment known as asset ID B03627823, which is directly issued by EI DUPONT DE NEMOURS & CO, is present in portfolios X, W and Z, yielding various exposure amounts (i.e., $82,009, $261,541 and $343,550, respectively).

In this exemplary analysis, the portfolio manager can evaluate exposure to specific investments either directly issued or investments in which EI DUPONT DE NEMOURS & CO is the underlier by each portfolio or the group as a whole, among other things.

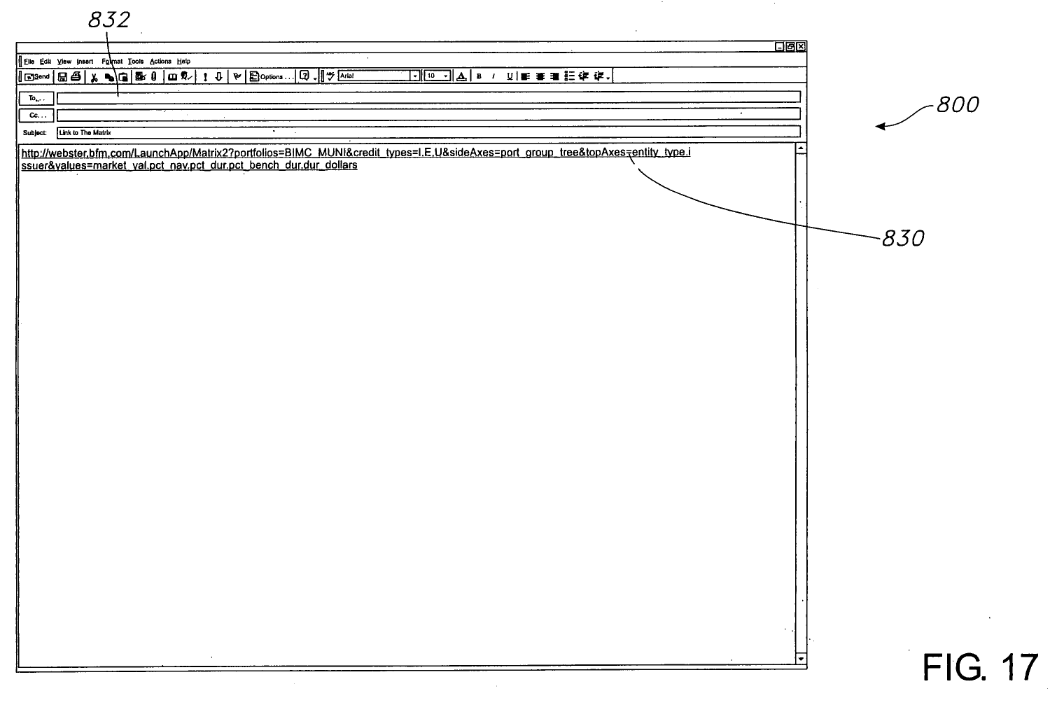

FIG. 17 illustrates a sample screen 800 of an email which provides a hyperlink 830 or immediate access to the results of an exposure analysis conducted by a system and method according to the present invention to any recipient(s) designated in address field 832. Preferably, screen 800 is automatically initiated upon selecting button 166 shown in the presentation screens of FIGS. 4-16.

In this example, link 830 is represented by the following code:
http://webster.bfm.com/LaunchApp/Matrix2?portfolios=BIMC_MUNI&credit_types=I.E.U&sideAxes=port_group_tree&topAxes=entity_type.issuer&values=market_val.pct_nav.pct_dur.pct_bench_dur.dur_dollars

Link 830 relates to an analysis in which the selected portfolio group is the BIMC_MUNI group, the credit type is not restricted in field 128, “Portgroup Tree” is selected in side axes menu 108 and “Issuer” is selected in top axes menu 110, and “Market Value,” “% NAV,” “% Duration,” “% Benchmark Duration,” and “Duration Dollar” are all selected as the comparative parameters in value menu 104.

With a connection to the World Wide Web, the recipient of the email shown in screen 800 can use link 830 to have instant access to the output screens from an exposure analysis conducted by system 10, such as the screens depicted in FIGS. 4-16. The accessed analysis report screens will be in static form so that the recipient of link 830 will not be able to reconfigure the analysis.

The present invention allows the portfolio manager to quantify, view and compare absolute exposure of the same portfolio group or relative exposure using a benchmark portfolio from numerous perspectives, among other things. Upon evaluating the absolute exposure or relative benchmark exposure analyses, the portfolio manager can adjust a portfolio's position in order to increase or decrease the portfolio's exposure. Preferably, the exposure evaluation system of the subject invention would be integrated within or operatively associated with a trade entry system so that the portfolio manager can enter and execute a buy or sell order accordingly.

Although the system and method of the subject invention have been described with respect to preferred embodiments, those skilled in the art will readily appreciate that changes and modifications may be made thereto without departing from the spirit and scope of the subject invention as defined by the appended claims.

1. A system for evaluating risk exposure across portfolios of investments, comprising:
a) a database for storing portfolio data and investment data, wherein the portfolio data relates to groupings of investments and the investment data includes information relating to attributes associated with the investments;
b) means for selecting a portfolio of interest from the database;
c) means for selecting a rule for categorizing the investments in the selected portfolio of interest by associated attributes included in the investment data;
d) means for selecting a comparative parameter;
e) means for categorizing the investments contained in the selected portfolio of interest according to the selected rule; and
f) means for quantifying the exposure of the selected portfolio of interest for each category of investment in terms of the selected comparative parameter.

2. A system as recited in claim 1, wherein the means for quantifying the exposure of the selected portfolios to the investments by category in terms of the selected comparative parameter includes quantifying an absolute exposure and a relative exposure in terms of the comparative parameter, wherein the relative exposure is the difference between exposure of a benchmark portfolio to investments by category and the exposure of the selected portfolios to the investments by category.

3. A system as recited in claim 1, wherein the means for quantifying the exposure of the selected portfolios to the investments by category in terms of the selected comparative parameter includes quantifying a total exposure in terms of the selected comparative parameter for the selected portfolios as a whole and by category.

4. A system as recited in claim 1, wherein the means for quantifying the exposure of the selected portfolios to the investments by category in terms of the selected comparative parameter includes quantifying the exposure of the selected portfolios to the investments by subcategories relating to each category in terms of the selected comparative parameter.

5. A system as recited in claim 1, further comprising means for illustrating the exposure of the selected portfolios to the investments by category in terms of the selected comparative parameter in a graphical format.

6. A system as recited in claim 1, further comprising means for illustrating the exposure of the selected portfolios to the investments by category in terms of the selected comparative parameter in a spreadsheet format.

7. A system as recited in claim 1, further comprising means for illustrating the exposure by portfolio in the selected portfolios to the investments by category in terms of the selected comparative parameter.

8. A system as recited in claim 1, further comprising means for illustrating the exposure of the selected portfolios to the investments by category in terms of the selected comparative parameter in an interactive spreadsheet and graph, wherein the graph and spreadsheet are responsive to computer-based stimuli to illustrate the exposure to subcategories and exposure by portfolio.

9. A system as recited in claim 1, further comprising means for delivering the quantified exposure in an electronic mail.

10. A system as recited in claim 1, wherein the comparative parameter is the market value.

11. A system as recited in claim 1, wherein the comparative parameter is the net asset value.

12. A method for evaluating risk exposure across portfolios of investments, comprising the steps of:
a) storing portfolio data and investment data, wherein the portfolio data relates to groupings of investments and the investment data includes information relating to attributes associated with the investments;
b) selecting a portfolio of interest from the database;
c) selecting a rule for categorizing the investments in the selected portfolio of interest by associated attributes included in the investment data;
d) selecting a comparative parameter;
e) categorizing the investments contained in the selected portfolio of interest according to the selected rule; and
f) quantifying the exposure of the selected portfolio of interest for each category of investment in terms of the selected comparative parameter.

13. A method according to claim 12, wherein the step of quantifying the exposure of the selected portfolio of interest for each category of investments in terms of the selected comparative parameter further comprises quantifying an absolute exposure and a relative exposure in terms of the selected comparative parameter, wherein the relative exposure is the difference between exposure of a benchmark portfolio to investments by category and the exposure of the selected portfolio to the investments by category.

14. A method according to claim 12, wherein the step of quantifying the exposure of the selected portfolio of interest for each category of investments in terms of the selected comparative parameter further comprises determining a total exposure in terms of the selected comparative parameter for the selected portfolio as a whole and by category.

15. A method according to claim 12, wherein the step of quantifying the exposure of the selected portfolio of interest for each category of investments in terms of the selected comparative parameter further comprises determining the exposure in terms of the selected comparative parameter of the selected portfolio of interest to the investments by subcategories relating to each category.

16. A method according to claim 12, further comprising the step of illustrating the exposure in terms of the selected comparative parameter of the selected portfolio to the investments by category in a graphical format.

17. A method according to claim 10, further comprising the step of illustrating the exposure in terms of the selected comparative parameter of the selected portfolio to the investments by category in a spreadsheet format.

18. A method according to claim 10, further comprising the step of illustrating the exposure in terms of the selected comparative parameter by portfolio in the selected portfolio to the investments by category.

19. A method according to claim 10, further comprising the step of illustrating the exposure in terms of the selected comparative parameter of the selected portfolio to the investments by category in an interactive spreadsheet and graph, wherein the graph and spreadsheet are responsive to computer-based stimuli to illustrate the exposure to subcategories and exposure by portfolio.

20. A method according to claim 10, further comprising the step of illustrating the exposure in terms of the selected comparative parameter of the selected portfolio to the investments by category in an electronic mail.

21. An executable program for implementing a method for evaluating risk exposure across portfolios of investments on a computer, the method comprising the steps of:
a) storing portfolio data and investment data, wherein the portfolio data relates to the groupings of investments and the investment data includes information relating to a plurality of attributes associated with investments;
b) selecting a portfolio of interest from the database;
c) selecting a rule for categorizing the selected portfolio of interest by associated attributes included in the investment data;
d) selecting a comparative parameter;
e) categorizing the investments contained in the selected portfolio of interest according to the selected rule; and
f) quantifying the exposure of the selected portfolio of interest for each category of investment in terms of the selected comparative parameter.

22. An executable program as recited in claim 21, wherein the program is stored on a machine readable media.

23. An executable program as recited in claim 21, wherein the program is provided by a connection to a data transfer device.

24. An executable program as recited in claim 21, wherein the program is accessible through a website on the World Wide Web.

25. A machine readable media for facilitating evaluation of risk exposure across portfolios of investments on a computer, comprising:
a) a data segment for,
i) storing portfolio data and investment data, wherein the portfolio data relates to the groupings of investments and the investment data includes information relating to a plurality of attributes associated with investments;
b) a code segment for,
i) selecting a portfolio of interest from the database;
ii) selecting a rule for categorizing investments in the selected portfolio of interest by associated attributes included in the investment data;
iii) selecting a comparative parameter;
iv) categorizing the investments contained in the selected portfolio of interest according to the selected rule; and
v) quantifying the exposure of the selected portfolio of interest for each category of investments in terms of the selected comparative parameter.
